(19) United States
(12) Patent Application Publication
(10) Pub. No.: US 2017/0072336 A1
(43) Pub. Date: Mar. 16, 2017

(54) A METHOD AND APPARATUS FOR MULTI-EFFECT ADSORPTION DISTILLATION

(71) Applicant: Medad Technologies Pte Ltd, Singapore (SG)

(72) Inventors: Su Hui Joseph Ng, Singapore (SG); Ang Li, Singapore (SG)

(21) Appl. No.: 15/123,450

(22) PCT Filed: Mar. 30, 2015
(86) PCT No.: PCT/SG2015/000103

§ 371 Date: Sep. 2, 2016

(30) Foreign Application Priority Data
Mar. 31, 2014 (SG) 10201401133P

(51) Int. Cl. B01D 3/14; B01D 53/04; B01D 1/26; B01D 3/06; C02F 1/04; C02F 1/06; C02F 1/16; B01D 1/00; B01D 53/26; B01D 5/00

(52) U.S. Cl. CPC B01D 3/146; B01D 53/261; B01D 53/0462; B01D 1/26; B01D 5/0003; B01D 5/0036; B01D 5/006; C02F 1/048; C02F 1/06; C02F 1/16; B01D 1/0058; B01D 3/065; B01D 2257/80; C02F 2103/08

(57) ABSTRACT

An apparatus for multi-effect adsorption distillation, the apparatus including a plurality of consecutive effects configured for evaporation of feed water therein; and a plurality of adsorber beds configured to adsorb vapor evaporated from feed water in a last effect of the plurality of consecutive effects and to release desorbed vapor during regeneration of the plurality of adsorber beds; wherein heat in the desorbed vapor is used to evaporate feed water fed into a first effect of the plurality of consecutive effects.

### FIELD OF INVENTION

The present invention relates to the field of distillation of saline or brackish water.

### BACKGROUND

Distillation is a practical but costly solution to water shortage problems encountered in regions of the world where rain fall is scarce and/or the population concentration is high. There are various types of commercial-scale distillation plants currently in operation, but typically, distillation plants display three main drawbacks, such as high energy usage to maintain relatively high temperatures, typically exceeding 110° C., overall high energy consumption of the plants and high maintenance costs of machine components arising from continual processing of salt water.

Therefore, distillation plants will become a more compelling and sustainable option for providing a solution to water shortage if running costs can be minimized.

### SUMMARY

According to a first aspect, there is provided an apparatus for multi-effect adsorption distillation, the apparatus including a plurality of consecutive effects configured for evaporation of feed water therein; and a plurality of adsorber beds configured to adsorb vapor evaporated from feed water in a last effect of the plurality of consecutive effects and to release desorbed vapor during regeneration of the plurality of adsorber beds; wherein heat in the desorbed vapor is used to evaporate feed water fed into a first effect of the plurality of consecutive effects.

The apparatus may be configured to channel the desorbed vapor into a heat exchange tube of the first effect.

Alternatively, the apparatus may further comprise a condenser in fluid connection with the plurality of adsorber beds, the condenser comprising a condenser tube in fluid communication with a heat exchange tube of the first effect, the condenser tube configured to allow heat in the desorbed vapor to be taken up by water in the condenser tube and circulated into the heat exchange tube of the first effect.

According to a second exemplary aspect, there is provided a method of multi-effect adsorption distillation, the method comprising placing a last effect of a plurality of consecutive effects in a state of low pressure; adsorbing vapor evaporated from feed water in the last effect using an adsorbent; regenerating the adsorbent to release desorbed vapor; using heat in the desorbed vapor to evaporate feed water in a first effect of the plurality of consecutive effects; using heat from vapor obtained in the first effect to evaporate feed water in a second effect of the plurality of consecutive effects; maintaining the plurality of consecutive effects at decreasing levels of pressure and temperature from the first effect to the last effect; and condensing vapor evaporated from feed water in the plurality of consecutive effects to obtain distillate.

Using heat in the desorbed vapor may comprise channeling the desorbed vapor into a heat exchange tube of the first effect.

Alternatively, using heat in the desorbed vapor may comprise water in a condenser tube of a condenser taking up heat in the desorbed vapor and circulating the heat into a heat exchange tube of the first effect.

### DESCRIPTION OF FIGURES

FIG. 1 is a schematic illustration of a first embodiment of an exemplary apparatus of the present invention;

FIG. 2 is a schematic illustration of a second embodiment of an exemplary apparatus of the present invention;

FIG. 3 is a schematic illustration of a third embodiment of an exemplary apparatus of the present invention;

FIG. 4 is a piping and instrumentation diagram of the apparatus of FIG. 3;

FIG. 5 is a graph of operating temporal temperature profiles the present invention;

FIG. 6 is a graph of transient water production rate of the present invention;

FIG. 7 is an operation performance chart of the present invention; and

FIG. 8 is a flow chart of an exemplary method of the present invention.

### DESCRIPTION OF INVENTION

The present invention relates to internally recovered energy that allows repeated reuse of latent heat for distillation in a multi-stage evaporator. Specifically, the present invention relates to the adsorption (AD) cycle where vapor regenerated from an adsorber bed is re-utilized for evaporation of sea or brackish feed water. Vapor from the last effect of the multi-stage evaporator is adsorbed by the adsorbent of the adsorber bed via hydrophilic properties of the adsorbent.

FIG. 1 shows a simplified view of a first embodiment of a multi-effect adsorption distillation apparatus 20. The apparatus 20 comprises a multi-stage evaporator having a plurality of consecutive effects 24(a), 24(b), 24(c), 24(d), 24(e) for evaporation of feed water 21 therein, and a plurality of adsorber beds 26(a), 26(b). A heat transfer tube 23 in the first effect 24(a) provides heat to evaporate feed water 21 that is fed into the first effect 24(a), leaving behind more saturated brine in the first effect. Vapor obtained in the first effect 24(a) is channeled into a heat transfer tube (not shown) in the second effect 24(b) to provide heat to evaporate feed water 21 that is fed into the second effect 24(b). Vapor obtained in the second effect 24(b) is channeled into a heat transfer tube (not shown) in the third effect 24(c) to provide heat to evaporate feed water 21 that is fed into the third effect 24(c), and so on. Thus, vapor obtained from one effect is channeled into the heat exchange tube of a next effect to evaporate feed water in the next effect, and this is repeated for subsequent effects. In the apparatus 20, this is achieved by configuring each effect to be in fluid communication with the heat exchange tube of a subsequent effect. Evaporating the feed water in the plurality effects leaves behind more saturated brine in each of the plurality of effects 24(a), 24(b), 24(c), 24(d), 24(e) that is channeled out via a brine stream 32. At the same time, the vapor in the heat transfer tubes in the plurality of effects condenses in the heat transfer tubes and is channeled out via a distillate stream 34.

The plurality of effects 24(a), 24(b), 24(c), 24(d), 24(e) are maintained at decreasing levels of pressure and temperature from the first effect 24(a) to the last effect 24(e) such that vapor emanating from the first effect 24(a) is condensed in the heat exchange tube of the second effect 24(b) through evaporation of the feed water in the second effect 24(b) at a lower pressure compared to the pressure in the first effect 24(a). This evaporation-condensation process is repeated in each subsequent effect until the last effect. A key feature to note is that temperature lower than ambient temperatures can still be recovered for multiple evaporation and condensation in the multi-effect stages.

Referring again to FIG. 1, the last effect 24(e) is placed in a state of low pressure. Feed water that is fed into the last effect 24(e) evaporates when a valve 30(a) or 30(b) connecting the last effect 24(e) to one of the adsorber beds 26(a), 26(b) is opened. This evaporation is achieved by the adsorption potential, that is, the affinity for water vapor of the anhydrous adsorbent in the adsorber beds 24(a), 24(b) and hence the mass transfer phenomena initiates the evaporation through lowered vapor pressure. By appropriately controlling the opening of the valves 30(a), 30(b) and the cooling and heating of the adsorbent in the adsorber beds 26(a), 26(b) evaporation in the last effect 24(e) can be configured to continually take place due to adsorption by one of the adsorber beds 26(a), 26(b). The continued vapor uptake by the adsorbent lowers the stage saturation temperature to as low as 3° to 10° C.

Cooling of the adsorbent in the adsorber beds 26(a), 26(b) during adsorption is preferably achieved using a water circuit to remove heat of adsorption until the adsorbent is fully saturated. The adsorption process is maintained until a preset time which is determined based on a heat source temperature, and the type of adsorbent used. Heating of the adsorbent in adsorber beds 26(a), 26(b) desorbs the adsorbent in the saturated adsorber beds 26(a), 26(b), thereby regenerating the adsorbent for adsorption by releasing adsorbed water from the adsorbent as desorbed vapor.

In this invention, heat in the desorbed vapor is used for evaporation of feed water in the plurality of effects 24(a), 24(b), 24(c), 24(d), 24(e) of the apparatus 20. In this first embodiment, reuse of heat in the desorbed vapor is achieved by channeling 40 the desorbed vapor of the adsorber beds 26(a), 26(b) into the heat transfer tube 23 in the first effect 24(a).

Thus, it will be appreciated that the apparatus 20 does not require an external heat source to provide the heat for vaporizing the feed water in the plurality of effects. Instead, the energy input for the evaporation of the feed water in the plurality of effects is supplied by the heat in the desorbed vapor from the adsorber beds in the adsorption cycle, where the top-brine-temperature (TBT) is from ambient to 50° C.

Accordingly, high gain-to-output ratio (GOR) is achieved because of the multiple evaporation and condensation stages while the only heat input for heating the adsorbent in the adsorber beds 26(a), 26(b) is from a low temperature heat source, for example, process waste heat or solar energy.

Advantageously, cooling energy from the brine and distillate streams can also be re-utilized for cooling of the adsorbent for improved performance.

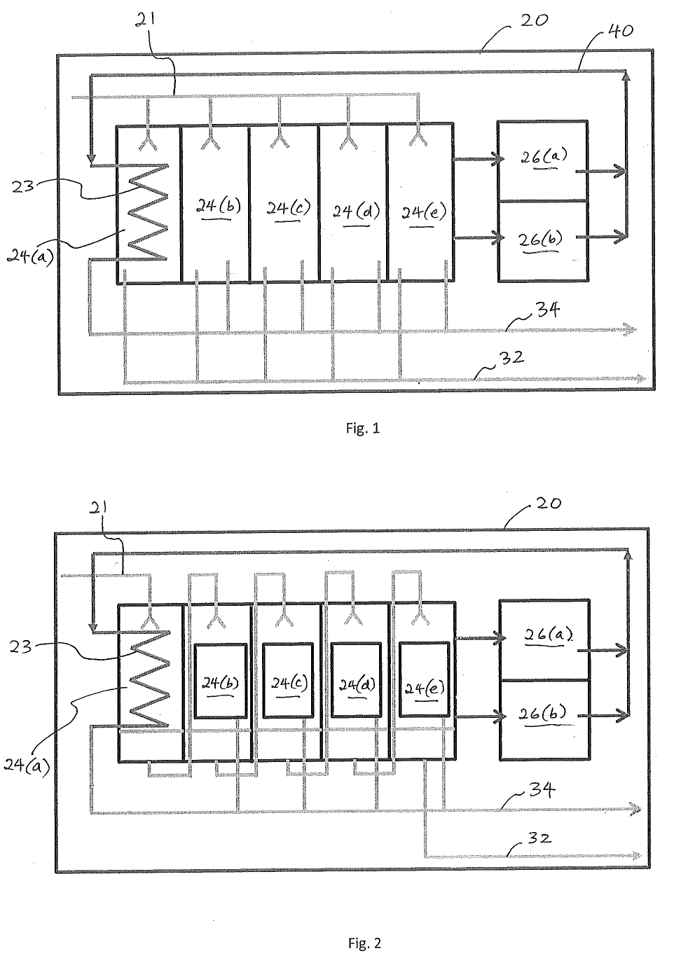

As shown in FIG. 1, the feed water 21 is fed into the plurality of effects 24(a), 24(b), 24(c), 24(d), 24(e) via a parallel feed in which each effect is provided with feed water 21 from the same source. In a second alternative embodiment of the apparatus 20 as shown in FIG. 2, the feed water 21 is fed into the plurality of effects 24(a), 24(b), 24(c), 24(d), 24(e) via a parallel feed in which brine that is left in a preceding effect e.g. 24(a) after evaporation is fed into a subsequent effect e.g. 24(b) as the feed water for evaporation in the subsequent effect. In the second embodiment, only brine from the last effect 24(e) is channeled out as the brine stream 32. In FIG. 2, components that are equivalent with those in the first embodiment shown in FIG. 1 have been labelled with the same reference numerals for ease of reference.

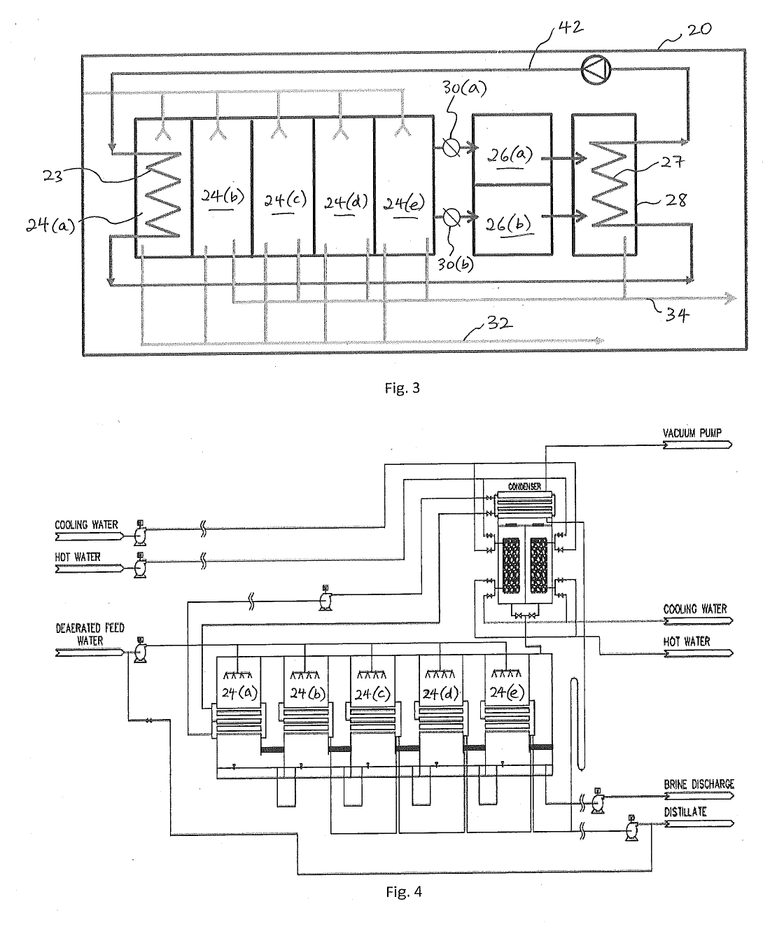

FIG. 3 shows a simplified view of a third embodiment of the apparatus 20 that further comprises a condenser 28. FIG. 4 shows a piping and instrumentation diagram of the third embodiment of FIG. 3. Components in FIGS. 3 and 4 that are equivalent with those in the first and second embodiments as shown in FIGS. 1 and 2 have been labelled with the same reference numerals for ease of reference. In this third embodiment, the energy required for evaporation of the feed water 21 in the first effect 24(a) is similarly provided by the heat in the desorbed vapor. However, unlike the first and second embodiments, in this third embodiment, heat in the desorbed vapor is taken up by a condenser tube 27 in the condenser 28 that is in fluid communication with the heat exchange tube 23 of the first effect 24(a). Water flowing in the condenser tube 27 and the heating exchange tube 23 of the first effect 24(a) thus forms a circulating water circuit 42 for transferring heat in the desorbed vapor to the first effect 24(a).

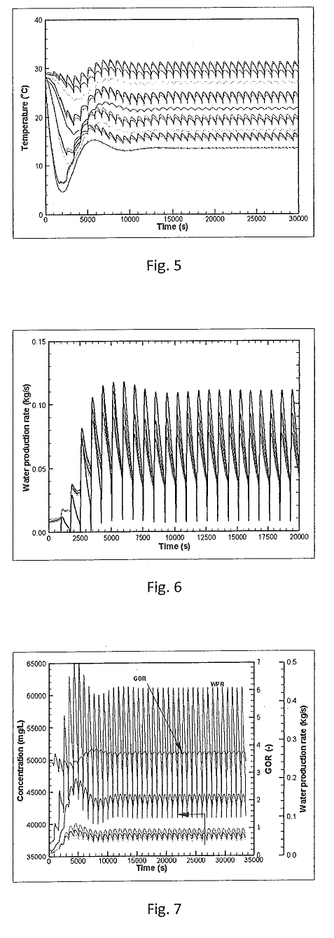

FIG. 5 shows temporal temperature profiles when operating the apparatus 20. It is observed that almost all the effects operate below ambient conditions. This is due to the vapor uptake by the adsorbent material from the AD cycle whereby energy input to the heat exchange tube 23 of the first effect is recovered from the heat in the desorbed vapor. It is observed that all the temperature profiles follow the cyclic nature of the adsorption cycle since the main driving energy for the evaporation in the plurality of effects is by the desorbed vapor. The transient water production rate of the apparatus 20 is shown in FIG. 6 where it is observed that the water production rate reflects the cyclic nature of the adsorption. The performance of the cycle is given in FIG. 7. Cycle average GOR is about 3.7 whilst the water production rate is about 0.265 kg/s translating to a specific daily water production rate of about 60 m³/tonne per day.

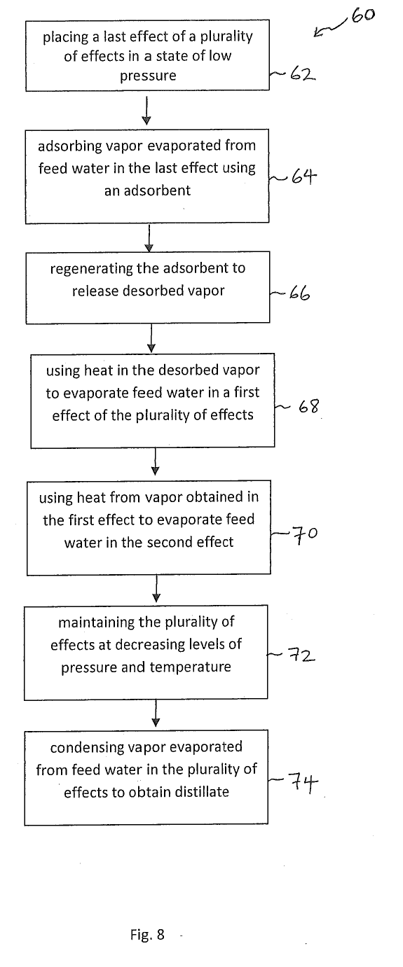

FIG. 8 shows a process flow for an exemplary method 60 for multi-effect adsorption distillation according to the present invention. Reference is made to the components described above and in the preceding figures. The method 60 comprises placing the last effect 24(e) in a state of low pressure 62. Evaporated vapor in the last effect 24(e) is then adsorbed by one of the adsorber beds 26(a), 26(b), until saturation 64. The saturated one of the adsorber beds 26(b) is regenerated to release desorbed vapor 66. Heat in the desorbed vapor is used to evaporate feed water in the first effect 24(a), 66. Heat in the vapor obtained in the first effect is used to provide heat for evaporating feed water in the second effect 70. This may be achieved by channeling the vapor from the first effect into a heat exchange tube of the second effect. Channeling of vapor from one effect into a heat exchange tube of a next effect to evaporate feed water in the next effect may be repeated for subsequent effects while maintaining the plurality of effects at decreasing levels of pressure and temperature 72. Vapor in the heat exchange tubes of the plurality of effects condenses in the heat exchange tubes during evaporation of the feed water and is channeled out as distillate 74.

It should be appreciated that both the apparatus 20 and the method 60 bring forth advantages and benefits including:
enabling high GOR for a heat-activated apparatus;
doing away with direct heating of feed water, thus not having to deal with scaling;
recovering evaporation energy in the process;
carrying out almost all evaporation processes at below ambient conditions; and
minimising cooling energy for the cooled brine and distillate streams.

Whilst there have been described in the foregoing description preferred embodiments of the present invention, it will be understood by those skilled in the technology concerned that many variations or modifications in details of design or construction may be made without departing from the present invention. For example, while the figures depict four effects and two adsorber beds, the number of effects and adsorber beds is not restricted to four and two respectively, and may be any plurality of at least two.

1. An apparatus for multi-effect adsorption distillation, the apparatus including:
a plurality of consecutive effects configured for evaporation of feed water therein;
a plurality of adsorber beds configured to adsorb vapor evaporated from feed water in a last effect of the plurality of consecutive effects and to release desorbed vapor during regeneration of the plurality of adsorber beds;
wherein heat in the desorbed vapor is used to evaporate feed water fed into a first effect of the plurality of consecutive effects.

2. The apparatus according to claim 1, wherein the apparatus is configured to channel the desorbed vapor into a heat exchange tube of the first effect.

3. The apparatus according to claim 1, further comprising a condenser in fluid connection with the plurality of adsorber beds, the condenser comprising a condenser tube in fluid communication with a heat exchange tube of the first effect, the condenser tube configured to allow heat in the desorbed vapor to be taken up by water in the condenser tube and circulated into the heat exchange tube of the first effect.

4. A method of multi-effect adsorption distillation, the method comprising:
placing a last effect of a plurality of consecutive effects in a state of low pressure;
adsorbing vapor evaporated from feed water in the last effect using an adsorbent;
regenerating the adsorbent to release desorbed vapor;
using heat in the desorbed vapor to evaporate feed water in a first effect of the plurality of consecutive effects;
using heat from vapor obtained in the first effect to evaporate feed water in a second effect of the plurality of consecutive effects;
maintaining the plurality of consecutive effects at decreasing levels of pressure and temperature from the first effect to the last effect; and
condensing vapor evaporated from feed water in the plurality of consecutive effects to obtain distillate.

5. The method of claim 4, wherein using heat in the desorbed vapor comprises channeling the desorbed vapor into a heat exchange tube of the first effect.

6. The method of claim 4, wherein using heat in the desorbed vapor comprises water in a condenser tube of a condenser taking up heat in the desorbed vapor and circulating the heat into a heat exchange tube of the first effect.
